(19) United States
(12) Patent Application Publication
(10) Pub. No.: US 2025/0167657 A1
(43) Pub. Date: May 22, 2025

(54) SUPERCONDUCTING MOTOR HAVING A COOLING SYSTEM

(71) Applicant: Airbus Operations SAS, TOULOUSE (FR)

(72) Inventors: Alexandre COLLE, TOULOUSE (FR); Reda ABDOUH, TOULOUSE (FR); Antoine DELARCHE, TOULOUSE (FR); François DUNOYER, TOULOUSE (FR); Camille CHAPER, TOULOUSE (FR)

(21) Appl. No.: 18/948,819

(22) Filed: Nov. 15, 2024

(30) Foreign Application Priority Data
Nov. 17, 2023 (FR) 2312641

(51) Int. Cl. H02K 55/00; H02K 15/04

(52) U.S. Cl. CPC H02K 55/00; H02K 15/0414; H02K 2215/00

(57) ABSTRACT

A superconducting motor comprising a rotor, a stator on the outside of the rotor penetrated by an even number of holes, for each pair of holes, a coil comprising a U-shaped base and U-shaped sheets and made from a superconducting material, in which the sheets are fixed to one another and to the base, in which each column of a coil is inserted into one of the holes of the pair of holes.

### CROSS-REFERENCES TO RELATED APPLICATIONS

This application claims the benefit of French Patent Application Number 2312641 filed on Nov. 17, 2023, the entire disclosure of which is incorporated herein by way of reference.

### FIELD OF THE INVENTION

The present invention relates to the general field of superconducting motors and, more particularly, to superconducting motors comprising a cooling system.

### BACKGROUND OF THE INVENTION

FIG. 5 shows a superconducting motor 300 from the prior art, in which the superconducting motor 300 is seen in cross-section along a plane perpendicular to the longitudinal axis X of said superconducting motor 300.

The superconducting motor 300 comprises a rotor 302 that has a rotor core 304 made of a ferromagnetic material, such as the totality of iron alloys used for electric machines. The rotor core 304 is cylindrical and coaxial with the longitudinal axis X and it has a central bore 306 in which a motor shaft 308 of said superconducting motor 300 is tightly fitted and rigidly fixed. The motor shaft 308 is also coaxial with the longitudinal axis X.

The rotor 302 also comprises permanent magnets 310 attached to the rotor core 304 on the periphery thereof. There are several permanent magnets 310 (six in this case) distributed angularly and evenly about the rotor core 304 and spaced apart from one another. Traditionally, the permanent magnets 310 are radially magnetized relative to the longitudinal axis X, with alternating polarization in close proximity.

The superconducting motor 300 comprises a stator 312 arranged outside the rotor 302 and a stator core 314 made from a ferromagnetic material, such as the totality of the iron alloys used in electric machines. The stator core 314 has a generally cylindrical shape that is coaxial with the longitudinal axis X.

On its cylindrical face which is oriented towards the rotor 302, the stator core 314 has slots 316 that open toward the rotor 302 in this case. There are several slots 316 (sixteen in this case) arranged angularly and evenly about the rotor 302. Successive slots 316 are separated by a tooth 318 that is made of a single piece and of one material with the stator core 314. The slots 316 are arranged in pairs. A pair of slots 316 is made up of two non-successive slots 316. In particular, the slots 316 in one pair of slots 316 are separated by two slots 316 that belong to different pairs of slots 316.

For each pair of slots 316, the stator 312 comprises a coil 320. A coil 320 is wound into a pair of slots 316 about a plurality of teeth 318. Each coil 320 is made from a superconducting material ribbon. Specifically, the superconducting material ribbon is wound radially along the longitudinal axis X in the slots 316 so as to form a coil 320. The coil 320 thereby forms a stack of superconducting ribbon in each slot 316. The superconducting ribbons are arranged perpendicular to the magnetic field lines that are inside the slots 316. Two slots 316 associated with the same coil 320 are separated by two slots 316 associated with two other coils 320. The coils 316 are thereby interleaved with one another in the slots 316.

The rotor 302 and stator 312 are typically housed in a cylindrical motor casing 322 that is closed at both ends by flanges, at least one of which has a central hole allowing the motor shaft 308 to pass through. The stator 312 is attached to the inside of the motor casing 322, while the rotor 302 and the motor shaft 308 are free to rotate inside the motor casing 322.

During operation, each coil 320 is electrically powered to generate a magnetic field that interacts with the permanent magnets 310, causing them to rotate with the rotor 302 and the motor shaft 308.

The superconducting motor 300 comprises an inner cylinder 324 and an outer cylinder 326 which are coaxial with the longitudinal axis X.

The inner cylinder 324 is positioned between the rotor 302 and the stator 312, and the outer cylinder 326 is positioned about the stator 312 and on the inside of the motor casing 322.

The inner cylinder 324 and the outer cylinder 326 extend between the two flanges to which they are hermetically sealed, forming between them and the two flanges a chamber 328, in which the stator 312 is housed and which can be evacuated to create a vacuum.

Within the framework of a superconducting motor 300, the coils 320 must be cooled to improve their efficiency. For this purpose, for each slot 316, tubes 330 are arranged at the bottom of the slot 316 between the coil 320 housed in the slot 316 and the stator core 314. These tubes 330 are fluidically connected to a source of a refrigerant. The refrigerant is then injected into the tubes 330 to cool the coils 320.

While an arrangement of this kind provides good results, it is desirable for a new arrangement to be found that simplifies the manufacturing process of the coils and the installation of these coils in the superconducting motor.

### SUMMARY OF THE INVENTION

An object of the present invention is to provide a superconducting motor comprising:
a rotor with a rotor core carrying permanent magnets which is rotatable about a longitudinal axis,
a stator arranged on the outside of the rotor and comprising a stator core made from a ferromagnetic material which has with an even number of holes distributed angularly and evenly about the rotor,
for each pair of holes, a coil comprising:
a U-shaped base with two first columns and a first bottom part fixed between the two first columns and
a plurality of sheets, each in a U-shape, with two second columns and a second bottom part, made from a superconducting material in which the sheets are fixed on top of one another to form a stack and in which said stack is fixed to the base by aligning each first column with the second columns of the sheets and the first bottom part with the second bottom parts of the sheets,
in which each column of a coil is inserted into one of the holes of the pair of holes.

With an arrangement of this kind, the manufacture and installation of the coils are simplified, as it is no longer necessary to wind a ribbon.

Advantageously, the base is drilled with a channel that has two openings, in which one opening exits at the end of each first column, in which the openings are intended to be fluidically connected to a cooling circuit.

Advantageously, the holes associated with the same coil are separated by two holes associated with two other coils.

The present invention also relates to an aircraft comprising at least one superconducting motor according to the invention.

Advantageously, the aircraft comprises a cooling circuit comprising a source of refrigerant, said source of refrigerant being fluidically connected to the openings of the base channel of the coil, the channel being configured to allow refrigerant to pass through between said openings.

The present invention also relates to a method for manufacturing a coil, comprising:
a step of additive manufacturing of a U-shaped base with two first columns and a first bottom part fixed between the two first columns,
a step of providing a plurality of sheets made from a superconducting material,
a step of stacking said plurality of sheets,
a step of cutting said stack of sheets in such a manner as to give said sheets a U-shape with two second columns forming the legs of the U and a second bottom part fixed between the two second columns, and
a step of attaching said stack of sheets to said base by aligning each first column with the second columns of the sheets and the first bottom part with the second bottom parts of the sheets.

Advantageously, the method comprises a step prior to the step of cutting of the stack of sheets, in which the sheets in the stack are fixed to one another.

Advantageously, after the step of cutting the stack of sheets, the method comprises a step of fixing the sheets in the U-shaped stack to one another.

### BRIEF DESCRIPTION OF THE DRAWINGS

The features of the invention mentioned above, as well as others, will become clearer upon reading the following description of an exemplary embodiment, said description being made in relation to the accompanying drawings, among which:

FIG. 1 is a sectional view of a superconducting motor according to the invention,

FIG. 2 is a perspective view of a coil used in the superconducting motor according to the invention,

FIG. 3 is a sectional view along curve III-III in FIG. 1,

FIG. 4 is a graph showing alternating current losses in the case of the invention and the prior art, and

FIG. 5 is a sectional view of a superconducting motor from the prior art.

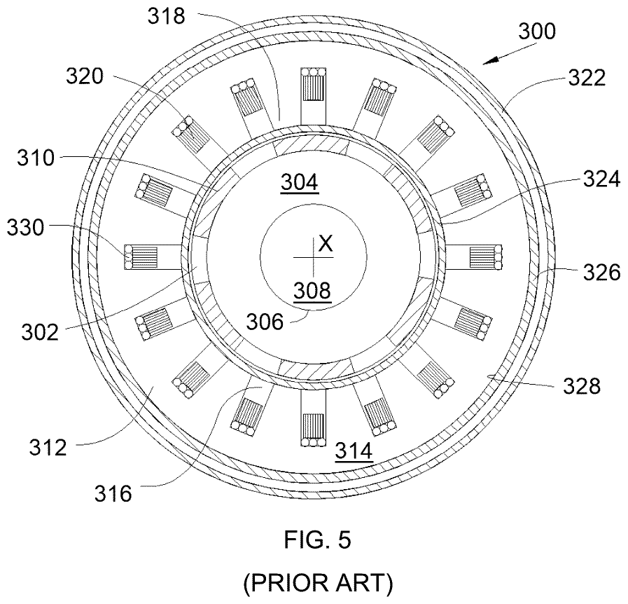

### DETAILED DESCRIPTION OF THE PREFERRED EMBODIMENTS

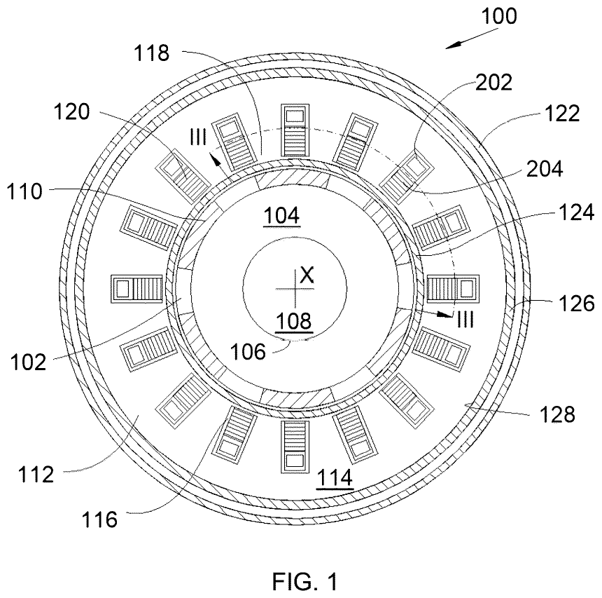

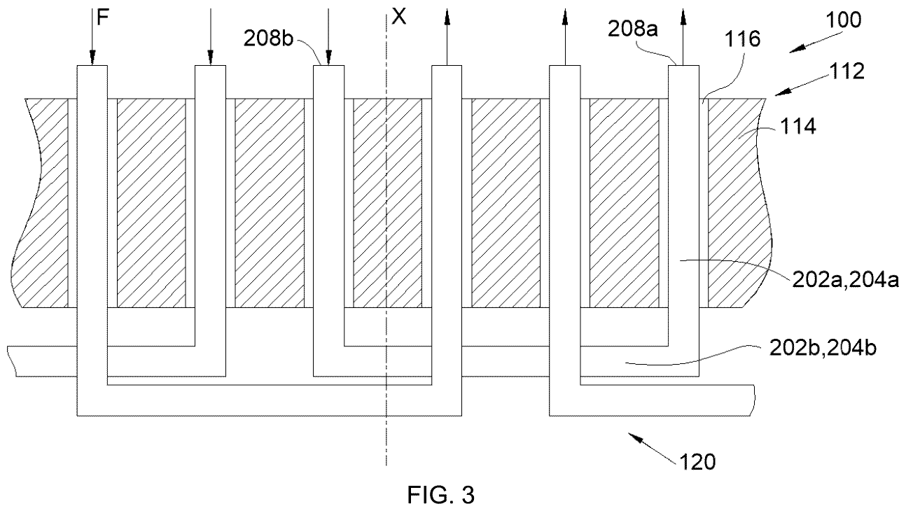

FIG. 1 shows a superconducting motor 100 according to the invention, in a section along a plane perpendicular to the longitudinal axis X of the superconducting motor 100 and FIG. 3 shows a section along arc III-III. The superconducting motor 100 has the same general structure as the superconducting motor 300 in the prior art.

The superconducting motor 100 comprises a rotor 102 which is rotatable about the longitudinal axis X and has a rotor core 104 made of a ferromagnetic material, such as the totality of the iron alloys used in electric machines. The rotor core 104 is cylindrical and coaxial with the longitudinal axis X and has a central bore 106 in which a motor shaft 108 of said superconducting motor 100 is tightly fitted and rigidly fixed. The motor shaft 108 is coaxial with the longitudinal axis X.

The rotor 102 also comprises permanent magnets 110 attached to the rotor core 104 on the periphery thereof. There are several permanent magnets 110 (six in this case) distributed angularly and evenly about the rotor core 104 and spaced apart from one another. Traditionally, the permanent magnets 110 are radially magnetized relative to the longitudinal axis X, with alternating north-south polarization in close proximity.

The superconducting motor 100 comprises a stator 112 arranged outside the rotor 102 and a cylindrical stator core 114 coaxial with the longitudinal axis X. The stator core 114 is made of a ferromagnetic material, such as the totality of the iron alloys used in electric machines.

The stator core 114 is penetrated by an even number of holes 116 (sixteen in this case) which are distributed angularly and evenly about the rotor 102. Two successive holes 116 are separated by a tooth 118 that is made of a single piece and of one material with the stator core 114. The holes 116 are closed in this case on the side facing the rotor 102, but each hole 116 can also take on the shape of a slot, as in the prior art.

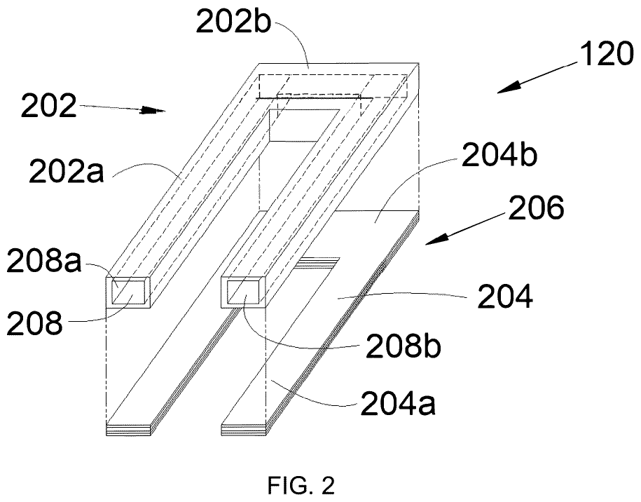

For each pair of holes 116, the superconducting motor 100 comprises a coil 120. FIG. 2 shows an example of a coil 120 according to the invention.

The coil 120 comprises a base 202 that is U-shaped with two first columns 202a forming the legs of the U and a first bottom part 202b fixed between the two first columns 202a, located at one end of each first column 202a and forming the base of the U.

The coil 120 also comprises a plurality of sheets 204, each in a U-shape, with two second columns 204a forming the legs of the U and a second bottom part 204b fixed between the two second columns 204a, located at one end of each second column 204a and forming the base of the U.

Each sheet 204 is made from a superconducting material, such as the totality of the iron alloys used for electric machines.

The sheets 204 are fixed, for example glued, to one another to form a stack 206, which also takes the shape of a U by stacking the second columns 204a on top of one another and the second bottom parts 204b on top of one another.

The stack 206 is fixed, for example glued, to the base 202 by aligning each first column 202a with one of the two stacks of second columns 204a of the sheets 204 and the first bottom part 202b with the stack of second bottom parts 204b of the sheets 204.

The coil 120 thereby takes on the general shape of a U with two columns and a bottom connecting the two columns. The two columns are each made of a stack of a first column 202a and second columns 204a and the bottom part is formed by the stack of the first bottom part 202b and second bottom parts 204b.

Each column 202a, 204a of a coil 120 is inserted into one of the holes 116 of the pair of holes 116, while the bottom part 202b, 204b of the coil 120 remains outside, as shown in FIG. 3. The columns 202a, 204a are parallel to the longitudinal axis X.

The manufacture of the coil 120 by assembling sheets 204 onto a base 202 is therefore easy to carry out and the installation and replacement of the coil 120 are also easy to carry out, as the columns 202a, 204a only need to be slid into the holes 116.

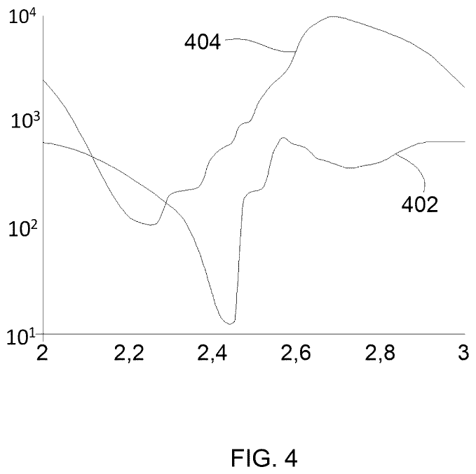

With an arrangement of this kind, the sheets 204 are arranged parallel to the magnetic field lines inside the holes 116. An arrangement of this kind also allows a reduction in energy losses compared with sheets that would be placed radially. FIG. 4 shows the evolution of alternating current losses of the motor for the invention (curve 402) and for a motor with radially installed sheets (curve 404). In FIG. 4, the horizontal axis represents time in milliseconds and the vertical axis represents losses in watts.

In the embodiment of the invention presented here, the rotor 102 and stator 112 are housed in a cylindrical motor casing 122 that is closed at both ends by flanges, at least one of which has a central hole allowing the motor shaft 108 to pass through. The stator 112 is fixed inside the motor casing 122, while the rotor 102 and the motor shaft 108 are mounted free to rotate inside the motor casing 122.

During operation, each coil 120 is electrically powered by an alternating current to generate a magnetic field that interacts with the permanent magnets 110, causing them to rotate with the rotor 102 and the motor shaft 108. For each coil 120, electrical power is supplied from the free ends of the second columns 204a, in other words, at the ends opposite the second bottom parts 204b. The free ends of the second columns 204a of one of the two stacks are thereby electrically connected to a terminal of an electric converter and the free ends of the second columns 204a of the other of the two stacks are thereby electrically connected to another terminal of the electric converter.

As with the superconducting motor 300 from the prior art, the superconducting motor 100 in this embodiment of the invention also comprises an inner cylinder 124 and an outer cylinder 126 which are both coaxial with the longitudinal axis X.

The inner cylinder 124 is arranged between the rotor 102 and the stator 112 and the outer cylinder 126 is arranged about the stator 112 and inside the motor casing 122.

The inner cylinder 124 and the outer cylinder 126 extend between the two flanges, to which they are hermetically sealed, forming between them (the two cylinders 124 and 126) and the two flanges, a chamber 128 in which the stator 112 is housed and which can be evacuated to create a vacuum.

To ensure the cooling of the sheets 204, the base 202 is drilled with a channel 208 with two openings 208a-b. One opening 208a-b exits at the free end of a first column 202a and the other opening 208b-a exits at the free end of the other first column 202a and the channel 208 thereby extends through the base 202 in the first columns 202a and in the bottom part 204b.

The openings 208a-b are fluidically connected to a cooling circuit that ensures the circulation of a refrigerant through the channel 208, entering through one opening 208a-b and leaving through the other opening 208b-a. The arrows F in FIG. 3 show the direction of movement of the refrigerant. The cooling circuit comprises, for example, a reservoir for the refrigerant and a pump to circulate the refrigerant.

The base 202 functions as a heat exchanger between the refrigerant and the sheets 204. The base 202 is made of a material that exhibits good thermal conductivity, such as a copper alloy, for example, to ensure proper heat transfer while reducing the induced losses associated with pure metals.

As shown in FIG. 3, the two holes 116 associated with a single coil 120 are separated by two holes 116 associated with two other coils 120, although they could also be adjacent.

The configuration shown in FIG. 3, where the two holes 116 associated with a single coil 120 are separated by two holes 116 associated with two other coils 120, allows for greater electro-mechanical conversion (in other words, it allows greater mechanical power to be obtained) with the same amount of electrical input current compared with a configuration in which the holes 116 associated with a coil 120 are adjacent.

The superconducting motor 100 is integrated into an aircraft comprising a cooling circuit with a refrigerant source that is fluidically connected to the openings 208a-b of the channel 208 in the base 202 of the coil 120. In particular, the channel 208 is configured to allow refrigerant to flow through between said openings 208a-b.

The method for manufacturing a coil 120 of this kind will now be described.

The method involves, starting with a plurality of superconducting material sheets 204, a step E10 of stacking said plurality of sheets 204 one on top of the other.

The method also involves, after step E10, a step E20 of cutting said stack of sheets 204 in such a manner as to give the sheets 204 a U-shape, with two second columns 204a forming the legs of the U and a second bottom part 204b fixed between the two second columns 204a, in this case at the end of each second column 204a and forming the base of the U.

The method involves upstream of, in parallel to, or after steps E10 and E20, a step E30 of creating the base 202 through additive manufacturing. The U-shaped base 202 with the two first columns 202a and the first bottom part 202b fixed between the two first columns 202a is produced by additive manufacturing (also known as ALM or Additive Layer Manufacturing).

The method involves, after steps E20 and E30, a step E40 of fixing the stack of the plurality of sheets 204 in a U-shape to the U-shaped base 202 to form the coil 120 by aligning each first column 202a of the base 202 with the second columns 204a of the sheets 204 and the first bottom part 202b of the base 202 with the second bottom parts 204b of the sheets 204. In particular, the stack of the plurality of sheets 204 can be glued to the base 202.

In one embodiment, during step E11, after step E10 and before step E20, the sheets 204 in this stack may be fixed, i.e. joined or bonded, for example glued, to one another.

In one embodiment, during step E21, after step E20 and before step E30, the U-shaped sheets 204 in this stack may be fixed, i.e. joined or bonded, for example glued, to one another.

The coil 120 thereby obtained is then integrated into the rotor 102 of the superconducting motor 100.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A superconducting motor comprising:
a rotor with a rotor core carrying permanent magnets which is configured to rotate about a longitudinal axis;
a stator arranged on an outside of the rotor and comprising a stator core made from a ferromagnetic material which has with an even number of holes distributed angularly and evenly about the rotor,
for each pair of holes, a coil, each coil comprising:
a U-shaped base with two first columns and a first bottom part fixed between the two first columns and
a plurality of sheets, each in a U-shape, with two second columns and a second bottom part, made from a superconducting material, wherein the sheets are fixed on top of one another to form a stack, and wherein said stack is fixed to the U-shaped base by aligning each first column with second columns and the first bottom part with the second bottom parts,
wherein each column of a coil is inserted into one of the holes of the pair of holes,
wherein the U-shaped base is drilled with a channel with two openings, one opening exiting at an end of each first column, and
wherein the openings are configured to be fluidically connected to a cooling circuit.

2. The superconducting motor according to claim 1, wherein the openings associated with each individual coil are separated by two holes associated with two other coils.

3. An aircraft comprising:
at least one superconducting motor according to claim 1.

4. The aircraft according to claim 3, further comprising:
a cooling circuit comprising a source of refrigerant, said source of refrigerant being fluidically connected to the two openings of the channel of the U-shaped base of the coil, said channel being configured to allow refrigerant to pass through between said two openings.

5. A method for manufacturing a coil comprising:
additive manufacturing of a U-shaped base with two first columns and a first bottom part fixed between the two first columns, the U-shaped base being drilled with a channel with two openings, wherein one opening exits at an end of each first column, wherein the two openings are configured to be fluidically connected to a cooling circuit,
providing a plurality of sheets made from a superconducting material,
stacking said sheets from the plurality of sheets to form a stack,
cutting said stack in such a manner as to give said sheets from the plurality of sheets a U-shape with two second columns forming legs of a U and a second bottom part, and
attaching the stack to said U-shaped base by aligning each first column with second columns and the first bottom part with the second bottom parts.

6. The method according to claim 5, further comprising:
prior to the cutting, fixing the sheets in the stack to one another.

7. The method according to claim 5, further comprising:
after the cutting, fixing the sheets in the stack to one another.
